(19) United States
(12) Patent Application Publication
(10) Pub. No.: US 2013/0102164 A1
(43) Pub. Date: Apr. 25, 2013

(54) MALE CONNECTOR AND FEMALE CONNECTOR IN COMPUTER SYSTEM

(71) Applicant: Kim Yeung Sip, Taipei Hsien (TW)

(72) Inventor: Kim Yeung Sip, Taipei Hsien (TW)

(73) Assignee: ACER INCORPORATED, Taipei Hsien (TW)

(21) Appl. No.: 13/415,549

(22) Filed: Mar. 8, 2012

(30) Foreign Application Priority Data
Oct. 21, 2011 (TW) 100138227

(51) Int. Cl. H01R 11/30; H01R 24/00

(52) U.S. Cl. 439/38; 439/660

(57) ABSTRACT

A male connector in a computer system is provided. The male connector has a plurality of male contacts for connecting with corresponding numbers of female contacts of a female connector in the computer system. The male contacts further have a first male contact having a data transmission interface, and a second male contact not having any data transmission interface.

### CROSS REFERENCE TO RELATED APPLICATIONS

This Non-provisional application claims priority under 35 U.S.C. §119(a) on Patent Application No(s). 100138227, filed in Taiwan, Republic of China on Oct. 21, 2011, the entire contents of which are hereby incorporated by reference.

### BACKGROUND OF THE INVENTION

1. Field of the Invention

The present invention relates to connectors in computer systems, and in particular relates to connections in daisy chain computer systems.

2. Description of the Related Art

A computer system is composed of various components such as chips (e.g., processors, south and north bridges) memories, and peripheral extension interfaces for connection with various peripheral devices (i.e., I/O devices). Users require more and more peripheral devices to improve the capability of the computer system, but these peripheral devices are not in use all the time. These standby peripheral devices not only occupy space but also waste computer resources. A desktop computer, which is already connected to all the peripheral devices in a fixed place, has full functions but is not portable; while a laptop computer, although portable, has limited functions due to lack of the peripheral devices.

To overcome the defects mentioned above, Acer Inc. provides a daisy chain computer system which is portable and expandable. FIG. 1 is a schematic diagram of the daisy chain computer system. The computer system 100, as shown in FIG. 1, has electronic devices M1˜M5, which are arranged along a direction and connected to each other as a daisy chain. The electronic devices M1˜M5 could be various kinds of peripheral devices. For example, the electronic device M1 may be the mainframe of the computer system which contain a CPU; the electronic device M2 may be a optical disk drive; the electronic device M3 may be a hard disk driver (HDD); the electronic device M4 may be a graphics processing unit (GPU); and the electronic device M5 may be a sound card with a speaker. On the one hand, for portability, the electronic devices M1˜M5 can be taken apart from each other and operate independently. On the other hand, the electronic devices M1˜M5 can be partly or fully integrated with each others, and operate together by sharing a same high speed transmission interface. The high speed transmission interface, for example, may be a thunderbolt interface (a new generation transmission interface). The daisy chain computer system is advantageous for connecting the peripheral devices in a random order, which makes the connection of the peripheral devices simple and prevents annoying, tangled wires found with the prior art.

Note that, as shown in FIG. 1, each of the electronic devices M1˜M5 has a male connector MC and a female connector FC on its front and rear sides for respectively connecting to its front and rear electronic devices in a daisy chain fashion. The high speed transmission interface can be shared through these male and female connectors. However, the disclosed daisy chain computer system fails to further define the type and arrangement of its connectors. Therefore, the present invention provides a new design for the connectors of the daisy chain computer system to improve the connection of the electronic devices in the computer system.

### BRIEF SUMMARY OF THE INVENTION

The present invention provides a male connector in a computer system. The male connector has: a plurality of male contacts, for connecting with corresponding numbers of female contacts of a female connector in the computer system, further comprising: a first male contact, having a data transmission interface; and a second male contact, not having any data transmission interface.

The present invention also provides a female connector in a computer system. The female connector has: has a plurality of female contacts, for connecting with corresponding numbers of male contacts of a male connector in the computer system, further comprising: a first female contact, having a data transmission interface; and a second female contact, not having any data transmission interface.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of the daisy chain computer system;

FIG. 2A shows a male connector 200A which is used in a daisy chain computer system according to an embodiment of the present invention;

FIG. 2B shows a female connector 200B for connecting with the male connector 200A in FIG. 2A;

FIG. 3 shows a set of male contacts;

FIG. 4 shows the connection between the male and the female contacts.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Data transmission connectors used in a computer system have become more and more fragile as size is gradually scaled down. The main purpose of the present invention is to provide a particular “fool proofing” design for the data transmission connectors for preventing them from damage due to improper plugging. This design will be further described in detail in the following embodiments.

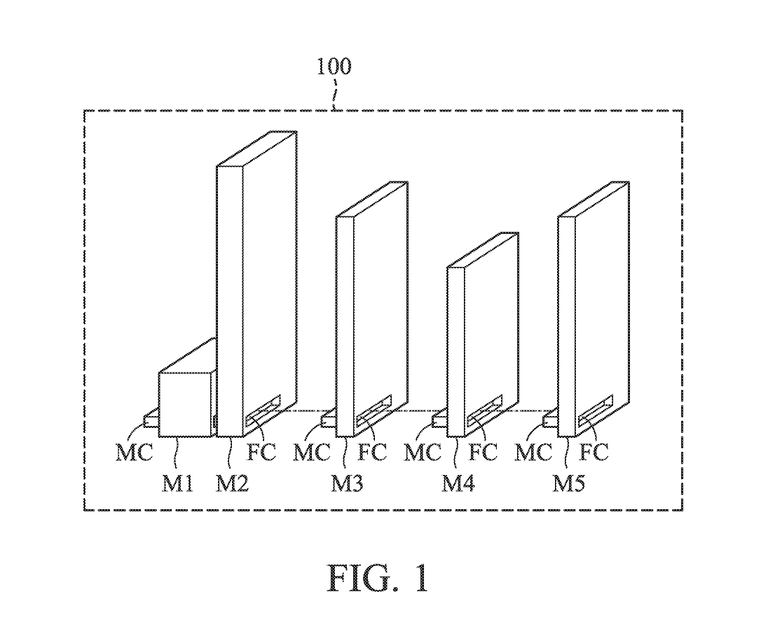

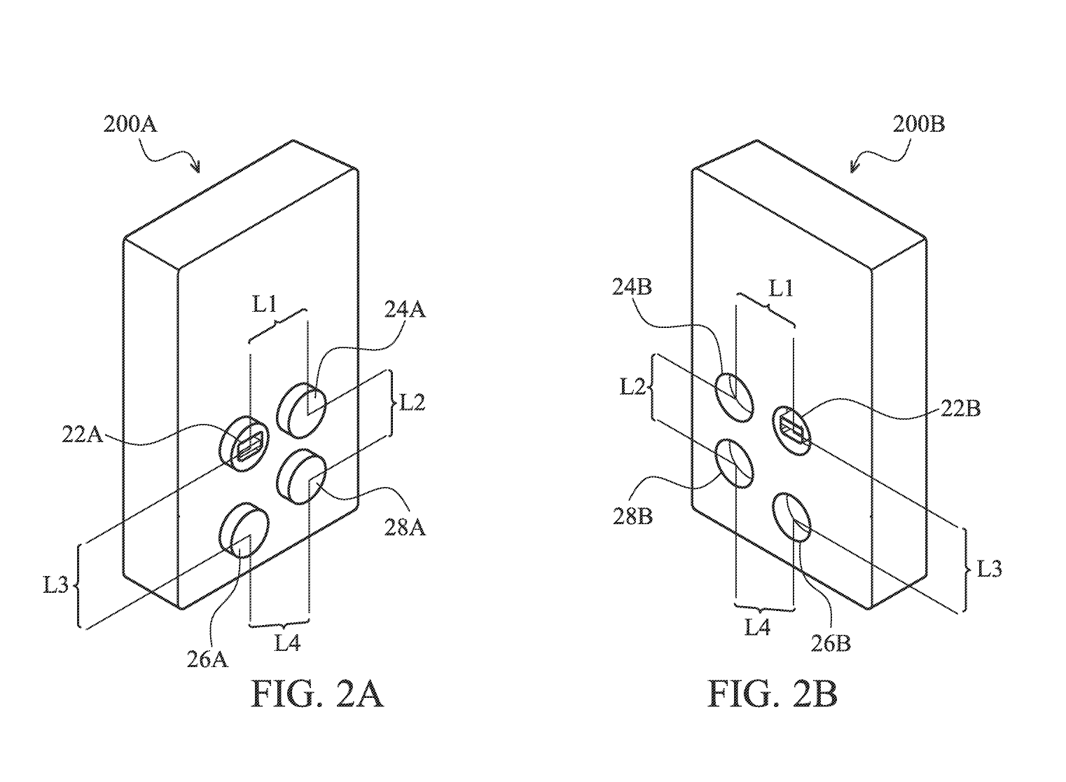

FIG. 2A shows a male connector 200A which is used in a daisy chain computer system according to an embodiment of the present invention; FIG. 2B shows a female connector 200B for connecting with the male connector 200A in FIG. 2A. The daisy chain computer system has been described above in accordance with FIG. 1 and will not be discussed in detail further. It should be noted that although the following embodiments are described by using the example of the daisy chain computer system, the present invention should not be limited thereto, and those skilled in the art can properly apply these male and female connectors in various computers or electronic systems. The male and the female connectors in the following embodiments, for example, can be located in the same places as those shown in FIG. 1, i.e., the front side and the rear side of each of the electronic devices.

FIG. 2A shows four male contacts 22A, 24A, 26A and 28A, which can be connected with four female contacts 22B, 24B, 26B and 28B in FIG. 2B. Both of the male contact 22A and the female contact 22B has a data transmission interface which can be connected to each other (note that the data transmission interface in the male contact 22A can be male or female, as long as it matches with the data transmission interface in the female contact 22B). In a best embodiment, the data transmission interface is a thunderbolt interface, which uses a new generation IO transmission technology for transmitting data with higher speed and electricity with larger power. In other embodiments, the data transmission interface should not be limited thereto, and can be any kind of the well-known interface, such as a USB, a PCI Express, or a FireWire interface, or the interface which will be used in the future.

As shown in FIGS. 2A and 2B, the male contacts 24A, 26A and 28A and the female contacts 24B, 26B and 28B are simply cylinder-shaped plugs and sockets without any interface disposed therein. This structure improves the steadiness of the connection between the male and the female connectors 200A and 200B, and, more importantly, can be used for preventing improper plugging. In an embodiment of the present invention, the male contacts 22A, 24A, 26A and 28A of the male connectors 200A can be arranged in an “asymmetrical polygon” manner or in a “non-equiangular polygon” manner; and, similarly, the female contacts 22B, 24B, 26B and 28B of the male connectors 200B can also be arranged in a mirrored “asymmetrical polygon” manner or in a mirrored “non-equiangular polygon” manner to match the male contacts 22A, 24A, 26A and 28A. Specifically, if the male contacts in FIG. 2A and the female contacts in FIG. 2B are all arranged in a square (a kind of “equiangular polygon”) or a rectangle (a kind of “symmetrical polygon”) manner, the male connector 200A and the female connector 200B may connect to each other in a wrong way so that the data transmission interfaces disposed in the male contact 22A and 22B may be damaged. Thus, the male contacts 22A, 24A, 26A and 28A in FIGS. 2A/the female contacts 22B, 24B, 26B and 28B in FIGS. 2B are arranged in an asymmetrical trapezoid which, although has equal sides L1 and L2, has unequal sides L3 and L3 for “fool proofing”.

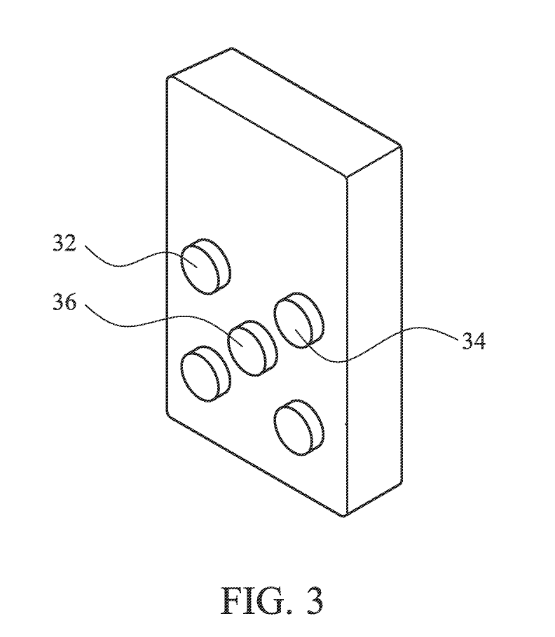

Note that although there are four male contacts and four female contacts described in the previous embodiment, the number of the contacts of a male or female connector should not be limited thereto. The “fool proofing” purpose of the present invention can be achieved as long as the “male/female contacts adjacent to each other” are arranged in the “asymmetrical polygon” or “non-equiangular polygon” manner. The term “contacts adjacent to each other” means a set of contacts which has non-intersected imaginary lines connected between any two of themselves. For example, as shown in FIG. 3, the number of the male contacts is five, where only three of the male contacts (e.g., 32, 34 and 35) can be regarded as a set of “contacts adjacent to each other” (which are arranged in a triangle manner). In addition, although the male contacts and female contacts in FIGS. 2A and 2B are all shown in cylinder shapes, they can be in other kinds of shapes in other embodiments.

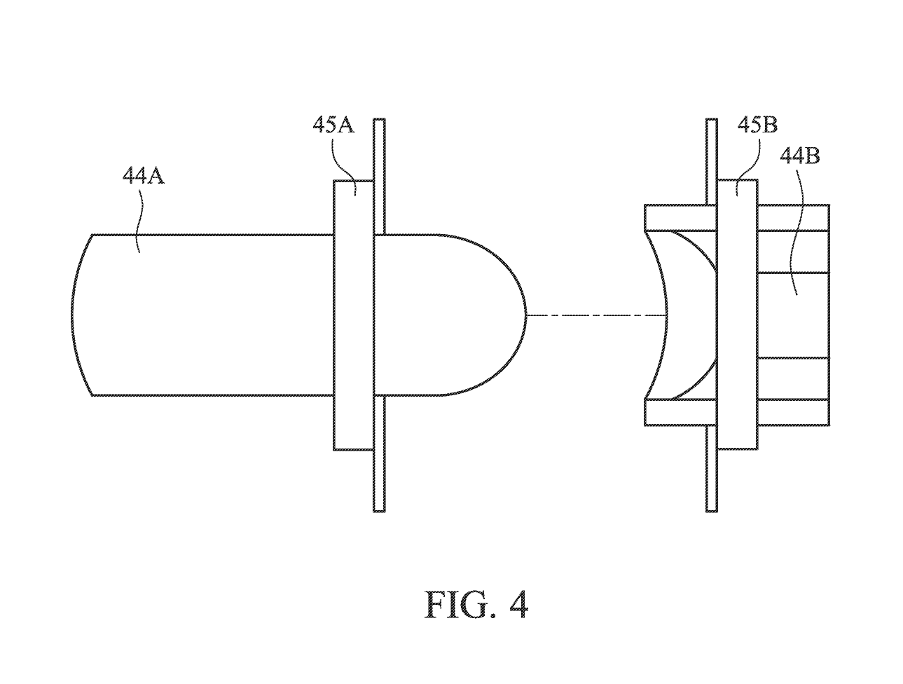

FIG. 4 shows the connection between the male and the female contacts. As shown in FIG. 4, for better connection, the female contact 44B has an internal diameter which is slightly larger than the outer diameter of the male contact 44A. In a better embodiment, the male contact 44A and the female contact 44B may be respectively surrounded by opposite magnetic poles 45A and 45B and use the attraction force which occurs between the magnetic poles 45A and 45B to increase the steadiness of their connection. In some embodiments, to prevent the computer system from crashing due to improper plugging of peripheral devices, various disconnection detectors can be further configured on the edge of the male contact 44A and the female contact 44B for detecting and informing the computer system of the disconnection between the male and the female contacts in advanced.

In some embodiments, the number, the shapes, the color, the material, and the arrangement of the male/female contacts (with or without data transmission interface) in the male/female connectors can be further designed in a “LEGO style” to improve user experience in assembling the computer system and enhance appearance of the computer system product.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A male connector in a computer system, comprising:
a plurality of male contacts, for connecting with corresponding numbers of female contacts of a female connector in the computer system, further comprising:
a first male contact, having a data transmission interface; and
a second male contact, not having any data transmission interface.

2. The male connector as claimed in claim 1, wherein the adjacent ones of the male contacts are arranged in an asymmetrical polygon or a non-equiangular polygon manner.

3. The male connector as claimed in claim 1, wherein the computer system is a daisy chain computer system.

4. The male connector as claimed in claim 1, wherein one of the male contacts comprises a magnetic pole.

5. The male connector as claimed in claim 1, wherein one of the male contacts comprises a disconnection detector.

6. A female connector in a computer system, comprising:
a plurality of female contacts, for connecting with corresponding numbers of male contacts of a male connector in the computer system, further comprising:
a first female contact, having a data transmission interface; and
a second female contact, not having any data transmission interface.

7. The female connector as claimed in claim 6, wherein the adjacent ones of the female contacts are arranged in an asymmetrical polygon or a non-equiangular polygon manner.

8. The female connector as claimed in claim 6, wherein the computer system is a daisy chain computer system.

9. The female connector as claimed in claim 6, wherein one of the female contacts comprises a magnetic pole.

10. The female connector as claimed in claim 6, wherein one of the female contacts comprises a disconnection detector.
